(19) United States
(12) Patent Application Publication
(10) Pub. No.: US 2026/0185201 A1
(43) Pub. Date: Jul. 2, 2026

(54) FE-BASED ALLOY AND ELECTRONIC COMPONENT INCLUDING THE SAME

(71) Applicant: SAMSUNG ELECTRO-MECHANICS CO., LTD., Suwon-si (KR)

(72) Inventors: Kaoru SATAKE, Suwon-si (KR); Sang Kyun KWON, Suwon-is (KR)

(73) Assignee: SAMSUNG ELECTRO-MECHANICS CO., LTD., Suwon-si (KR)

(21) Appl. No.: 19/399,186

(22) Filed: Nov. 24, 2025

(30) Foreign Application Priority Data
Dec. 27, 2024 (KR) 10-2024-0198895

(51) Int. Cl. C22C 45/02; C22C 38/00; C22C 38/02; C22C 38/10; C22C 38/12; C22C 38/16; H01F 1/147; H01F 27/28

(52) U.S. Cl. CPC C22C 45/02; C22C 38/002; C22C 38/02; C22C 38/10; C22C 38/12; C22C 38/16; H01F 1/14766; H01F 27/28; C22C 2200/02; C22C 2200/04; C22C 2202/02

(57) ABSTRACT

The present disclosure relates to an Fe-based alloy expressed by a compositional formula of (Fe₍₁₋ₓ)Coₓ)ₐSi_{b}B_{c}P_{d}NbₑCu_{f}C_{g}, wherein x, a, b, c, e, and g satisfy the conditions of 10≤x≤20, 80.0≤a≤82.0, 0≤b≤4.0, 8.0≤c≤12.0, 0≤d≤4.0, 1.0≤e≤3.0, 0.5≤f≤1.0, 0≤g≤2.0.

### CROSS-REFERENCE TO RELATED APPLICATION(S)

This application claims benefit of priority to Korean Patent Application No. 10-2024-0198895 filed on Dec. 27, 2024 in the Korean Intellectual Property Office, the disclosure of which is incorporated herein by reference in its entirety.

### TECHNICAL FIELD

The present disclosure relates to an Fe-based alloy and an electronic component including the same.

In the technical fields of inductors, transformers, motor cores, wireless power transmission devices, etc., development of soft magnetic materials having improved miniaturization and high-frequency characteristics has been in progress. In particular, in the case of using power inductors in a high-current region, an overlapping characteristic is often problematic. In relation thereto, inductors have been designed by considering the number of coil turns, coil shape, cross-sectional region, magnetic field, shape of magnetic material particles, distance, and insulation in order to prevent inductance from decreasing. However, since there are restrictions on an inductor shape, coil DC resistance value, and inductance value, it is desirable to improve a saturation magnetic flux density of a magnetic material.

In addition, it is also important to reduce core loss in power inductors. Core loss is expressed as the sum of hysteresis loss and eddy current loss, and in order to reduce hysteresis loss, it is important to lower the coercivity of a magnetic material.

### SUMMARY

An aspect of the present disclosure is to provide an Fe-based alloy in which loss is minimized, while having a high saturation magnetic flux density but a low coercivity, and the electronic component using the same.

According to an aspect of the present disclosure, an Fe-based alloy is expressed by a compositional formula of (Fe₍₁₋ₓ₎COₓ)ₐSi_{b}B_{c}NbₑCu_{f}C_{g}, wherein x, a, b, c, e, and g satisfy the conditions of 10≤x≤20, 80.0≤a≤82.0, 0≤b≤4.0, 8.0≤c≤12.0, 0≤d≤4.0, 1.0≤e≤3.0, 0.5≤f≤1.0, 0≤g≤2.0.

The Fe-based alloy may include amorphous and crystalline phases.

The crystalline phase may include at least one selected from the group consisting of an Fe crystal and an Fe—Co crystal.

A content of the amorphous phase among the amorphous phase and the crystalline phase may be 90% or more.

The crystalline phase may exist within the amorphous phase.

An average particle diameter of the crystalline phase may be 3 nm to 30 nm.

In the compositional formula, in some embodiment, b≤d.

According to another aspect of the present disclosure, an electronic component includes: a coil portion; and a body covering the coil portion and including a plurality of magnetic particles, wherein the plurality f magnetic particles are expressed by a compositional formula of (Fe₍₁₋ₓ)Coₓ)ₐSi_{b}B_{c}P_{d}NbₑCu_{f}C_{g}, wherein x, a, b, c, e, and g satisfy the conditions of 10≤x≤20, 79.0≤a≤82.0, 0≤b≤4.0, 8.0≤c≤12.0, 0≤d≤4.0, 1.0≤e≤3.0, 0.55f≤1.0, and 0≤g≤2.0.

The Fe-based alloy may include an amorphous phase and a crystalline phase.

The crystalline phase may include at least one selected from the group consisting of an Fe crystal and an Fe—Co crystal.

A content of the amorphous phase among the amorphous phase and the crystalline phase may be 90% or more.

The crystalline phase may exist within the amorphous phase.

An average particle diameter of the crystalline phase may be 3 nm to 30 nm.

In the compositional formula, in some embodiment, b≤d.

The electronic component may further include: a support substrate disposed within the body and supporting the coil portion.

The coil portion may include a winding-type coil.

The electronic component may further comprise an external electrode disposed outside the body, wherein the external electrode includes a conductive paste layer and a plating layer.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a schematic perspective view illustrating a coil component according to an embodiment of the present disclosure;

FIG. 2 is a cross-sectional view taken along line I-I′ of FIG. 1;

FIG. 3 is an enlarged view of a body region of the coil component of FIG. 2;

FIG. 4 is an enlarged view of magnetic particles; and

FIG. 5 is a schematic perspective view illustrating a coil component according to another embodiment of the present disclosure.

### DETAILED DESCRIPTION

Hereinafter, embodiments of the present disclosure will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

### Electronic Component

Hereinafter, an electronic component according to an embodiment of the present disclosure is described, and a coil component is selected as a representative example. However, it should be noted that a Fe-based alloy described below may be applied to other electronic components, such as wireless charging devices, filters, or the like in addition to coil components.

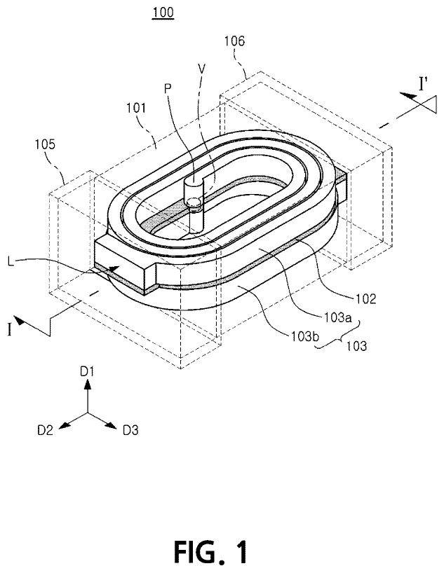

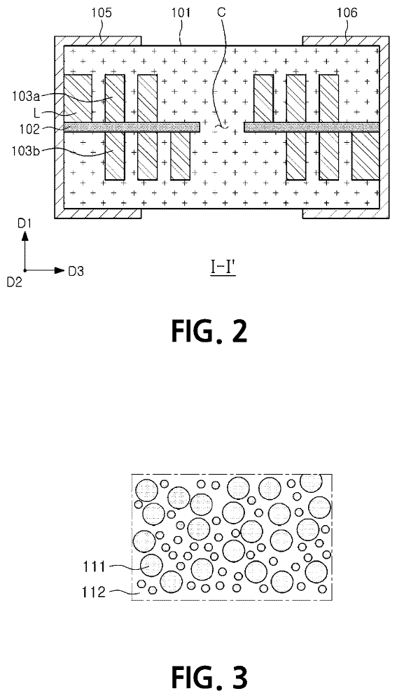

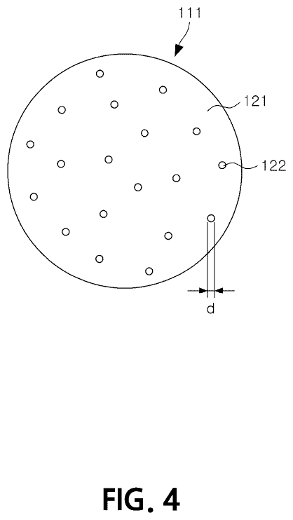

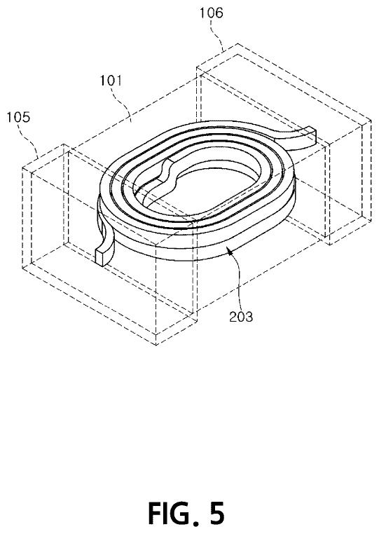

FIG. 1 schematically is a perspective view illustrating an outer appearance of a coil component according to an embodiment of the present disclosure. In addition, FIG. 2 is a cross-sectional view taken along line I-I′ of FIG. 1. FIG. 3 is an enlarged view of a body region of the coil component of FIG. 2, and FIG. 4 is an enlarged view of magnetic particles. FIG. 5 is a schematic perspective view illustrating a coil component according to another embodiment of the present disclosure.

First, referring to FIGS. 1 and 2, a coil component 100 according to an embodiment of the present disclosure mainly includes a body 101, a support substrate 102, a coil portion 103, and external electrodes 105 and 106, and the body 101 includes a plurality of magnetic particles 111.

The body 101 may cover and protect the coil portion 103 and may include a plurality of magnetic particles 111, as illustrated in FIG. 3. Specifically, the magnetic particles 111 may be dispersed in an insulator 112 formed of resin, etc. In this case, the magnetic particles 111 may be soft magnetic powder particles and may include an Fe-based alloy. A specific composition of the Fe-based alloy included in the magnetic particles 111 will be described below. The use of the Fe-based alloy of the composition proposed in the present embodiment may ensure exhibition of magnetic properties suitable for use in an inductor by maintaining soft magnetic characteristics, while supporting a high level of saturation magnetic flux density.

The support substrate 102 may support the coil portion 103 and may be formed of a polypropylene glycol (PPG) substrate, a ferrite substrate, or a metal-based soft magnetic substrate. As illustrated in the figure, a central portion of the support substrate 102 may be penetrated to form a through-hole, and the through-hole may be filled with the body 101 to form a magnetic core portion C.

The coil portion 103 is installed inside the body 101 and plays a role in performing various functions in the electronic device through the characteristics manifested by a coil of the coil electronic component 100. For example, the coil electronic component 100 may be a power inductor, in which case the coil portion 103 may store electricity in the form of a magnetic field to maintain an output voltage and stabilize power. In this case, coil patterns forming the coil portion 103 may be laminated on both sides of the support substrate 102, respectively, and may be electrically connected through a conductive via V penetrating through the support substrate 102. The coil portion 103 may be formed to have a spiral shape, and the outermost portion of the spiral shape may include a lead portion L exposed to the outside of the body 101 for electrical connection with external electrodes 105 and 106.

The coil portion 103 is disposed on at least one selected from the group consisting of a first surface (an upper surface in FIG. 2) and a second surface (a lower surface in FIG. 2) opposing each other on the support substrate 102. As in the present embodiment, the coil portion 103 may be disposed on both the first surface and the second surface of the support substrate 102, and in this case, the coil portion 103 may include a pad region P. However, unlike this, the coil portion 103 may be disposed on only one surface of the support substrate 102. Meanwhile, a coil pattern forming the coil portion 103 may be formed using a plating process used in the art, such as pattern plating, anisotropic plating, isotropic plating, etc., and may be formed to have a multilayer structure using a plurality of processes among these processes.

The coil portion may be provided in a form other than the form illustrated in FIG. 1, and for example, a coil portion 203 may be implemented as a winding type as in the embodiment illustrated in FIG. 5. In this case, a support substrate supporting the coil portion 203 may not be disposed inside the body 101. The coil portion 203 may be a winding coil formed by winding a metal wire, such as a copper wire (Cu-wire) including a metal wire and a coating layer covering a surface of the metal wire. Therefore, the entire surface of each of the plurality of turns of the coil portion 203 may be covered with the coating layer. Meanwhile, the metal wire may be a flat wire, but is not limited thereto. When the coil portion 203 is formed as a flat wire, the cross-section of each turn of the coil portion 203 may be rectangular. The coating layer may include epoxy, polyimide, liquid crystal polymer, etc. alone or in combination, but is not limited thereto.

The external electrodes 105 and 106 may be formed outside the body 101 and may be formed to be connected to a lead portion L. The external electrodes 105 and 106 may include a conductive paste layer formed by using a paste including a metal having excellent electrical conductivity, and may be, for example, a conductive paste including at least one selected from the group consisting of nickel (Ni), copper (Cu), tin (Sn), and silver (Ag), and alloys thereof. In addition, a plating layer (not illustrated) may be further formed on the external electrodes 105 and 106. In this case, the plating layer may include at least one selected from the group consisting selected from the group consisting of nickel (Ni), copper (Cu), and tin (Sn), and for example, a nickel (Ni) layer and a tin (Sn) layer may be formed sequentially.

As described above, in the case of the present embodiment, the magnetic particles 111 include an Fe-based alloy having excellent magnetic properties when manufactured in a powder form. Hereinafter, the characteristics of the Fe-based alloy that may be included in the magnetic particles 111 will be described in detail. However, the Fe-based alloy described below may also be utilized in a metal sheet form, etc. in addition to a powder form. In addition, such an alloy may be utilized in transformers, motor cores, electromagnetic shielding sheets, etc. in addition to inductors.

### Fe-Based Alloy

According to the research of the inventors of the present disclosure, the Fe-based alloy having the composition proposed in the present embodiment has high amorphousness in the powder state, so the saturation magnetic flux density is excellent, while the coercivity may be maintained at a low level. The reason why the coercivity may be maintained low is because, when manufacturing powder particles through an atomization process, etc., Fe or Fe—Co crystalline phases are precipitated in addition to the amorphous phase within the Fe-based alloy. In the case of the Fe-based alloy, although it is not subjected to a heat treatment process for nanocrystal precipitation, a crystalline phase may be partially precipitated within an amorphous phase in the powder state after atomization. Specifically, the Fe alloy is expressed by a compositional formula of Fe₍₁₋ₓ₎Coₓ)ₐSi_{b}B_{c}P_{d}NbₑCu_{f}C_{g}, wherein x, a, b, c, e, and g satisfy the conditions of 10≤x≤20, 79.0≤a≤82.0, 0≤b≤4.0, 8.0≤c≤12.0, 0≤d≤4.0, 1.0≤e≤3.0, 0.5≤f≤1.0, 0≤g≤2.0. The Fe-based alloy satisfying these compositions may have a high level of saturation magnetic flux density, while maintaining the coercivity low level. In addition, these characteristics may be maintained even when the alloy is manufactured as powder particles having high amorphousness and then is not separately subjected to a heat treatment process for forming nanocrystals.

Referring to FIG. 4, the magnetic particles 111 including the Fe-based alloy according to the present embodiment may include an amorphous phase 121 and a crystalline phase 122, and the crystalline phase 122 may include at least one selected from the group consisting of an Fe crystal and an Fe—Co crystal. The ratio of the amorphous phase 121 and the crystalline phase 122 may be adjusted in order to suppress an excessive increase in coercivity, while maintaining a high level of saturation magnetic flux density. Accordingly, in the present embodiment, in the amorphous phase 121 and the crystalline phase 122, the volume content of the amorphous phase 121 is set to be 90% or more. The relative content of the amorphous phase 121 and the crystalline phase 122 may be obtained through the volume occupied in the magnetic particle 111 or the area occupied in one cross-section of the magnetic particle 111. Here, the relative content based on the area of the cross-section may be obtained through the cross-section of a plurality of magnetic particles 111 exposed on one cross-section of the body 101, and in this case, an average value may be obtained by taking a plurality of cross-sections of the body 101. As illustrated in the form of FIG. 4, the crystalline phase 122 may exist inside the amorphous phase 121. An average particle diameter d of the crystalline phase 122 may be 3 nm to 30 nm, and here, the average particle diameter d may be an average of values measured on one cross-section of the magnetic particles 111. In addition, the average particle diameter d may be obtained through the cross-section of the plurality of magnetic particles 111 exposed on one cross-section of the body 101, and in this case, an average value may also be obtained by taking a plurality of cross-sections of the body 101.

The method for measuring the particle diameters of the amorphous phase 121 and the crystalline phase 122 is described in detail. First, in a cross-sectional image, such as an SEM, the particle diameters of the amorphous phase 121 and the crystalline phase 122 may be obtained through an image obtained from a cross-section of one surface of the magnetic body 101, for example, a cross-section in the first direction-third direction D1-D3 cut in the middle of the second direction D2 of the magnetic body 101 in FIG. 2 and may be an average value for the plurality of magnetic particles 111. In addition, the particle diameters of the amorphous phase 121 and the crystalline phase 122 may be the major axis lengths, respectively. However, in some cases, the area of the particle diameters of the amorphous phase 121 and the crystalline phase 122 in the cross-section of the magnetic body 101 may be calculated and then converted into an equivalent circle diameter. In addition, the magnetic particles 111 in an outer region of the magnetic body 101 may be deformed due to a compression process, etc., the particle diameter may be measured by excluding the region corresponding to a length within 5% or 10% from the surface of the magnetic body 101. The particle diameter of the amorphous phase 121 and the crystalline phase 122 cannot be obtained from only one cross-section of the magnetic body 101 and may be calculated by averaging a plurality of values obtained from a plurality of cross-sections. Here, the plurality of cross-sections of the magnetic body 101 may be, for example, a plurality of cross-sections (for example, 5 or more cross-sections) in the first direction-third direction D1-D3 spaced at equal intervals in both directions from the middle of the magnetic body 101 in the second direction D2.

The main elements constituting the Fe-based alloy will be described. First, Fe is a main element of the Fe-based alloy and is an essential element responsible for magnetism. Similarly, Co is an element replacing a portion of Fe and obtaining a high saturation magnetic flux density. The content of Fe and Co is preferably 80.0 to 82.0 mol % in the Fe-based alloy with respect to a total amount of elements in the Fe-based alloy. If the sum of Fe and Co is less than 80 mol %, amorphousness may be improved and crystal precipitation may not occur. Meanwhile, if the sum of Fe and Co is greater than 82 mol %, the content of Fe and Co is excessive and it may be difficult to obtain soft magnetic powder having a high level of amorphous phase, for example, an amorphous phase of 90% or more. In addition, it is preferable that the molar ratio of Fe and Co be set to 10% or more and 20% or less of Co relative to Fe, that is, 10≤x≤20 in the compositional formula. If the content of Co is less than 10%, it may be difficult to confirm the improvement of the saturation magnetization characteristics, and if the content of Co exceeds 20%, the amorphousness may be improved but the saturation magnetization characteristics tend to deteriorate.

Si is an element affecting amorphousness, and thus may contribute to reducing the core loss of magnetic particles. Si may be included in an amount of 0 to 4 mol % (i.e., 0≤b≤4.0) in the Fe-based alloy. B is an element affecting amorphousness, and in particular, B may be necessary for the amorphous phase to be formed at a high level of 90% or more in the Fe-based alloy. B may be included in an amount of 8 to 12 mol % (i.e., 8.0≤c≤12.0) in terms of improving amorphousness and reducing core loss.

P is an element affecting amorphousness and may be included in an amount of 0 to 4 mol % (i.e., 0≤d≤4.0) in the Fe-based alloy. In this case, the content of P may be equal to or greater than the content of Si. That is, bsd in the compositional formula. If the content of P exceeds 4 mol %, the amorphous phase may increase relatively and the balance between the Fe-based element and the amorphous forming element may deteriorate, which may lower the saturation magnetic flux density.

Nb may prevent crystal coarsening after nanocrystal precipitation in the soft magnetic powder. By controlling the content of Nb, the core loss may be controlled to the intended level, while a high saturation magnetic flux density is obtained. The content of Nb is preferably 1 to 3 mol % (i.e., 1.0≤e≤3.0) with respect to a total amount of elements in the Fe-based alloy. If the content of Nb is less than 1 molo, the effect of preventing crystal coarsening tends to decrease, and when the content of Nb exceeds 3 mol %, the effect of coarsening the crystal did not change significantly compared to when 3 mol % was added.

Cu is preferably added in an amount of 0.5 to 1.0 mol % (i.e., 0.5≤f≤1.0) to the Fe-based alloy. If Cu is less than 0.5 mol % with respect to a total amount of elements in the Fe-based alloy, crystal precipitation is rarely obtained, and if Cu exceeds 1 mol %, the amount of crystal precipitation tends to increase. In this respect, the content of Cu may be determined as described above in order to obtain an amorphous phase at a level of 90% or more. C is an element responsible for the amorphous form and may be included in an amount of 0 mol % or more and 2.0 mol % or less (i.e., 0≤g≤2.0) with respect to a total amount of elements in the Fe-based alloy. When the content of C is 2 mol % or less, the amorphousness of the Fe-based alloy may be improved. However, an excessive addition of C may inhibit the amorphousness and cause deterioration of the soft magnetic characteristics.

Other trace elements that may be included in the Fe-based alloy are described, and examples of these elements include Al, Ti, S, N, and O. These other elements may be mixed in the raw materials or manufacturing process and may affect the characteristics of the Fe-based alloy. Therefore, it is desirable to control the content of these trace elements. First, Al and Ti are trace elements that may be mixed in the soft magnetic powder particles manufactured using industrial raw materials, such as Fe—P or Fe—B, and in this case, the ratio of the amorphous phase or the soft magnetic characteristics may be reduced due to Al and Ti. Therefore, the content of each of Al and Ti is preferably 0.05 mass % or less in order to prevent the ratio of the amorphous phase from decreasing, and more preferably 0.005 mass % or less in order to suppress the effect on the improvement of the ratio of the amorphous phase and the soft magnetic characteristics.

S may be mixed into the soft magnetic powder manufactured using industrial raw materials, such as Fe—P or Fe—B, and an addition of a small amount of S has the effect of promoting the spheroidization of the soft magnetic powder. However, an addition of an excessive amount of S may cause the organization of non-uniform nanocrystals or a decrease in the soft magnetic characteristics. Therefore, the content of S is preferably 0.5 mass % or less with respect to a total amount of the soft magnetic powder in order to avoid a decrease in the soft magnetic characteristics, and more preferably 0.05 mass % or less. N may be derived from industrial raw materials or mixed into the soft magnetic powder in the air during atomization or heat treatment, and in this case, it may cause a decrease in the ratio of the amorphous phase, a deterioration in the filling property during molding, and a decrease in the soft magnetic characteristics. Therefore, in order to sufficiently secure the amorphous phase and suppress the deterioration of the soft magnetic characteristics, the content of N is preferably 0.01 mass % or less, and more preferably 0.002 mass % or less with respect to a total amount of the soft magnetic powder. Oxygen (O) may be derived from industrial raw materials or may be mixed into the soft magnetic powder in the air during atomization or drying, and in this case, it may cause a decrease in the amorphous phase ratio of the soft magnetic powder, deterioration of the filling property during molding, and a decrease in the soft magnetic characteristics. Therefore, in order to suppress the deterioration of the amorphous phase ratio, the content of oxygen (O) is preferably 1.0 mass % or less. In addition, in order to suppress the deterioration of the soft magnetic characteristics of the soft magnetic powder, the content of oxygen (O) is more preferably 0.3 mass % or less.

Meanwhile, the analysis of the components constituting the Fe-based alloy and the content of each component may be performed by the following process. For example, it may be performed by the following process. First, there is an electron probe micro analyzer (EPMA) method as a composition analysis method of the magnetic particle 111, and in this method, after the cross-section of the coil component 100 is polished, when an electron beam accelerated from an electron gun at about 15 to 30 kV is collided with the surface of the magnetic particle 111, X-rays having a unique wavelength (energy) for each component of the magnetic particle 111 are generated, which are measured by a detector to identify a chemical composition. In this case, a region analyzed by the EPMA is a local region of the magnetic particle 111, and thus, a plurality of measurement points (for example, 5 or more measurement points) may be analyzed at equal intervals on the surface of the magnetic particle 111 and an average value thereof may be used. Another analysis method is an inductively coupled plasma (ICP) method. In this method, a polymer component in the electronic component is removed by using a liquid capable of decomposing the polymer component, and then the coil is removed by using a physical method, etc. Thereafter, the remaining magnetic particles 111 may be dissolved in an acidic solution and the components thereof may be analyzed using an inductively coupled plasma atomic emission spectrometer (ICP-AES). In addition, transmission electron microscopy with energy dispersive spectroscopy (TEM-EDS) analysis, scanning electron microscopy with energy dispersive spectroscopy (SEM-EDS) analysis, etc. may be used. The analysis methods described above may be performed using the cross-section of the magnetic component 100 based on FIG. 2. As an example, the composition of the Fe alloy included in the magnetic particles 111 may be obtained through an image obtained from the cross-section in the first direction-third direction D1-D3 cut in the middle of the magnetic body 101 in the second direction D2 and may be an average value for the plurality of magnetic particles 111. In addition, this analysis process may be performed on a plurality of cross-sections of the magnetic body 101, for example, on a plurality of cross-sections (for example, 5 or more cross-sections in the first direction-third direction D1-D3 spaced equally apart in both directions from the middle of the magnetic body 101 in the second direction D2, and then an average value may be calculated.

The magnetic particles 111 according to the present embodiment may be manufactured by various manufacturing methods. For example, in a powder manufacturing process by an atomization method, such as a water atomization method or a gas atomization method for obtaining the magnetic particles 111 which are soft magnetic powder particles, first, raw materials are weighed and melted to have a predetermined composition to manufacture a molten alloy. Then, the molten alloy is discharged from a nozzle and divided into alloy volumes using high-pressure gas or water, thereby manufacturing fine soft magnetic powder particles. In addition, in this powder particle manufacturing process, the shape and particle diameter of the soft magnetic powder particles may be adjusted by changing the manufacturing conditions. In the case of the present embodiment, in order to improve the degree of amorphization, the maximum particle diameter of the magnetic particles 111 may be 100 μm or less. In addition, if the particle diameter distribution of the magnetic particles 111 is excessively wide, unintended particle diameter segregation may be induced. Considering this, the maximum particle diameter of the magnetic particles 111 may be limited to 100 μm or less.

In addition, with respect to the size of the magnetic particles 111, D₅₀ of the magnetic particles 111 may be about 20 to 40 μm. The diameters of the plurality of magnetic particles 111 may be obtained through an image obtained from one surface of the magnetic body 101, for example, an image obtained from a cross-section in the first direction-third direction D1-D3 cut in the middle of the magnetic body 101 in the second direction D2 in FIG. 2 and may be an average value for the plurality of magnetic particles 111. In addition, the diameters of the plurality of magnetic particles 111 may be the major-axis lengths of the magnetic particles 111. However, in some cases, if the magnetic particles 111 in the cross-section of the magnetic body 101 are not circular, the area of the magnetic particles 111 may be calculated and then converted into an equivalent circle diameter. In this case, since the outer region of the magnetic body 101 may be deformed by a compression process or the like, the diameter may be measured by excluding a region corresponding to a length within 5% or 10% from the surface of the magnetic body 101. Meanwhile, the diameters of the plurality of magnetic particles 111 may not be obtained from only one cross-section of the magnetic body 101 and may be calculated by averaging a plurality of values obtained from a plurality of cross-sections. Here, the plurality of cross-sections of the magnetic body 101 may be, for example, a plurality of cross-sections (for example, 5 or more cross-sections) in the first direction-third direction D1-D3 spaced equally apart in both directions from the middle of the magnetic body 101 in the second direction D2.

The inventors of the present disclosure conducted experiments on the amorphousness and magnetic properties (saturation magnetization, coercivity) according to the composition of the Fe-based alloy, and the results are illustrated in Tables 1 to 4 below. Here, Table 1 illustrates the alloy composition, crystallinity (amorphous, crystalline, mixed phase of the two phases), and the degree of crystallinity of comparative examples, and Table 2 illustrates the saturation magnetization and coercivity of some comparative examples. Table 3 illustrates the alloy composition, crystallinity, and the degree of crystallinity of examples, and Table 4 illustrates the saturation magnetization and coercivity of examples. In order to evaluate the characteristics of Fe-based alloys, the gas-atomized molten alloy was rapidly cooled with cooling water to produce soft magnetic powder particles having an average particle diameter of 25 μm, and the cores for inductors were manufactured using the same. In addition, the precipitated phases in the soft magnetic powder particles manufactured according to the composition of the Fe-based alloy were evaluated by X-ray diffraction (XRD) to calculate a ratio of the amorphous phase. In this case, the average particle diameter and the degree of crystallinity of the crystalline phase may be calculated by analyzing the X-ray diffraction measurement results by the whole-powder-pattern decomposition method (WPPD), and in the degree of crystallinity, the content of the crystalline phase was calculated by % based on the sum of the amorphous phase and the crystalline phase taken as 100%. In the case of magnetic properties, the saturation magnetization (emu/g) and coercivity (Hc) were measured using a vibrating sample magnetometer (VSM).

TABLE 1

| | | | Degree of |
|---|---|---|---|
| | | | crystal- |
| | Composition | Crystallinity | linity |
| Comparative | FeSiCr | crystalline | 100% |
| Example 1 | | | |
| Comparative | Fe₇₉Si₆B₁₃C₂ | amorphous | 0% |
| Example 2 | | | |
| Comparative | Fe_{73.5}Si_{13.5}B₉Nb₃Cu₁ | amorphous | 0% |
| Example 3 | | | |
| Comparative | Fe₈₃B₁₂P₄Nb_{0.5}Cu_{0.5} | crystalline | 100% |
| Example 4 | | | |
| Comparative | (Fe₉₀Co₁₀)₈₃B₁₂P₄Nb_{0.5}Cu_{0.5} | crystalline | 100% |
| Example 5 | | | |
| Comparative | (Fe₈₀Co₂₀)₈₃B₁₂P₄Nb_{0.5}Cu_{0.5} | crystalline | 100% |
| Example 6 | | | |
| Comparative | Fe₈₃Si₄B₁₂Nb_{0.5}Cu_{0.5} | crystalline | 100% |
| Example 7 | | | |
| Comparative | (Fe₉₀Co₁₀)₈₃Si₄B₁₂Nb_{0.5}Cu_{0.5} | crystalline | 100% |
| Example 8 | | | |
| Comparative | (Fe₈₀Co₂₀)₈₃Si₄B₁₂Nb_{0.5}Cu_{0.5} | crystalline | 100% |
| Example 9 | | | |
| Comparative | Fe₈₃Si4B₈P₄Nb_{0.5}Cu_{0.5} | crystalline | 100% |
| Example 10 | | | |
| Comparative | (Fe₉₀Co₁₀)₈₃Si₄B₈P₄Nb_{0.5}Cu_{0.5} | crystalline | 100% |
| Example 11 | | | |
| Comparative | (Fe₈₀Co₂₀)₈₃Si₄B₈P₄Nb_{0.5}Cu_{0.5} | crystalline | 100% |
| Example 12 | | | |
| Comparative | Fe₈₂B₁₂P₄Nb₁Cu₁ | crystalline | 100% |
| Example 13 | | | |
| Comparative | Fe₈₂Si₄B₁₂Nb₁Cu₁ | crystalline | 100% |
| Example 14 | | | |
| Comparative | Fe₈₂Si₄B₈P₄Nb₁Cu₁ | crystalline | 100% |
| Example 15 | | | |
| Comparative | Fe₈₂Si_{0.5}B₁₂P₄Nb₁Cu_{0.5} | crystalline | 100% |
| Example 16 | | | |
| Comparative | Fe₈₂B₁₂P₄Nb₁Cu₁ | crystalline | 100% |
| Example 17 | | | |
| Comparative | Fe₈₁Si₄B₈P₄Nb₁Cu₁C₁ | crystalline | 100% |
| Example 18 | | | |
| Comparative | Fe₈₀Si₄B₈P₄Nb₃Cu₁ | crystalline | 100% |
| Example 19 | | | |
| Comparative | Fe₈₀Si₂B₁₂P₄Nb₁Cu₁ | crystalline | 100% |
| Example 20 | | | |
| Comparative | Fe₈₀B₁₂P₄Nb₁Cu₁C₁ | crystalline | 100% |
| Example 21 | | | |
| Comparative | Fe₈₀B₁₂P₄Nb₁Cu₁C₂ | crystalline | 100% |
| Example 22 | | | |
| Comparative | Fe₇₉Si4B₁₂P₄Nb₁Cu₁ | amorphous | 0% |
| Example 23 | | | |
| Comparative | (Fe₉₀Co₁₀)₇₉Si4B₁₂P₄Nb₁Cu₁ | amorphous | 0% |
| Example 24 | | | |
| Comparative | (Fe₈₀Co20)₇₉Si4B₁₂P₄Nb₁Cu₁ | amorphous | 0% |
| Example 25 | | | |
| Comparative | Fe₇₉Si4B₁₁P₂Nb₁Cu₁C₂ | amorphous | 0% |
| Example 26 | | | |
| Comparative | (Fe₉₀Co₁₀)₇₉Si4B₁₁P₂Nb₁Cu₁C₂ | amorphous | 0% |
| Example 27 | | | |
| Comparative | (Fe₈₀Co20)₇₉Si4B₁₁P₂Nb₁Cu₁C₂ | amorphous | 0% |
| Example 28 | | | |

TABLE 2

| | Saturation | |
|---|---|---|
| | magnetization | Coercivity |
| | (emu/g) | (Oe) |
| Comparative | 187 | 6.8 |
| Example 1 | | |
| Comparative | 168 | 2.1 |
| Example 2 | | |
| Comparative | 130 | 0.5 |
| Example 3 | | |
| Comparative | 164 | 2.6 |
| Example 23 | | |
| Comparative | 162 | 2.4 |
| Example 24 | | |
| Comparative | 163 | 2.6 |
| Example 25 | | |
| Comparative | 162 | 2.4 |
| Example 26 | | |
| Comparative | 161 | 2.5 |
| Example 27 | | |
| Comparative | 161 | 2.5 |
| Example 28 | | |

TABLE 3

| | | | Degree of |
|---|---|---|---|
| | | | crystal- |
| | Composition | Crystallinity | linity |
| Example 1 | (Fe₉₀Co₁₀)₈₂B₁₂P₄Nb₁Cu₁ | amorphous + | 5% |
| | | crystalline | |
| Example 2 | (Fe₈₀Co₂₀)₈₂B₁₂P₄Nb₁Cu₁ | amorphous + | 5% |
| | | crystalline | |
| Example 3 | (Fe₉₀Co₁₀)₈₂Si₄B₁₂Nb₁Cu₁ | amorphous + | 4% |
| | | crystalline | |
| Example 4 | (Fe₈₀Co₂₀)₈₂Si₄B₁₂Nb₁Cu₁ | amorphous + | 4% |
| | | crystalline | |
| Example 5 | (Fe₉₀Co₁₀)₈₂Si₄B₈P₄Nb₁Cu₁ | amorphous + | 4% |
| | | crystalline | |
| Example 6 | (Fe₈₀Co₂₀)₈₂Si₄B₈P₄Nb₁Cu₁ | amorphous + | 4% |
| | | crystalline | |
| Example 7 | (Fe₉₀Co₁₀)₈₂Si_{0.5}B₁₂P₄Nb₁Cu_{0.5} | amorphous + | 4% |
| | | crystalline | |
| Example 8 | (Fe₈₀Co₂₀)₈₂Si_{0.5}B₁₂P₄Nb₁Cu_{0.5} | amorphous + | 4% |
| | | crystalline | |
| Example 9 | (Fe₉₀Co₁₀)₈₂B₁₂P₄Nb₁Cu₁ | amorphous + | 3% |
| | | crystalline | |
| Example 10 | (Fe₈₀Co₂₀)₈₂B₁₂P₄Nb₁Cu₁ | amorphous + | 3% |
| | | crystalline | |
| Example 11 | (Fe₉₀Co₁₀)₈₁Si₄B₈P₄Nb₁Cu₁C₁ | amorphous + | 3% |
| | | crystalline | |
| Example 12 | (Fe₈₀Co₂₀)₈₁Si₄B₈P₄Nb₁Cu₁C₁ | amorphous + | 3% |
| | | crystalline | |
| Example 13 | (Fe₉₀Co₁₀)₈₀Si₄B₈P₄Nb3Cu₁ | amorphous + | 3% |
| | | crystalline | |
| Example 14 | (Fe₈₀Co₂₀)₈₀Si₄B₈P₄Nb3Cu₁ | amorphous + | 3% |
| | | crystalline | |
| Example 15 | (Fe₉₀Co₁₀)₈₀S₁₂B₁₂P₄Nb₁Cu₁ | amorphous + | 3% |
| | | crystalline | |
| Example 16 | (Fe₈₀Co₂₀)₈₀S₁₂B₁₂P₄Nb₁Cu₁ | amorphous + | 3% |
| | | crystalline | |
| Example 17 | (Fe₉₀Co₁₀)₈₀B₁₂P₄Nb₁Cu₁C₁ | amorphous + | 3% |
| | | crystalline | |
| Example 18 | (Fe₈₀Co₂₀)₈₀B₁₂P₄Nb₁Cu₁C₁ | amorphous + | 3% |
| | | crystalline | |
| Example 19 | (Fe₉₀Co₁₀)₈₀B₁₂P₄Nb₁Cu₁C₂ | amorphous + | 2% |
| | | crystalline | |
| Example 20 | (Fe₉₀Co₂₀)₈₀B₁₂P₄Nb₁Cu₁C₂ | amorphous + | 2% |
| | | crystalline | |

TABLE 4

| | Saturation | |
|---|---|---|
| | magnetization | Coercivity |
| | (emu/g) | (Oe) |
| Example 1 | 169 | 2.9 |
| Example 2 | 170 | 3.1 |
| Example 3 | 170 | 2.9 |
| Example 4 | 170 | 2.9 |
| Example 5 | 169 | 2.8 |
| Example 6 | 169 | 2.8 |
| Example 7 | 170 | 2.8 |
| Example 8 | 171 | 2.7 |
| Example 9 | 169 | 2.8 |
| Example 10 | 168 | 2.8 |
| Example 11 | 171 | 2.7 |
| Example 12 | 170 | 2.8 |
| Example 13 | 169 | 2.4 |
| Example 14 | 168 | 2.3 |
| Example 15 | 168 | 2.2 |
| Example 16 | 168 | 2.3 |
| Example 17 | 169 | 2.4 |
| Example 18 | 169 | 2.3 |
| Example 19 | 170 | 2.3 |
| Example 20 | 168 | 2.3 |

Referring to the experimental results above, comparative examples that do not satisfy the composition conditions of the Fe-based alloy according to the embodiment of the present disclosure merely have an amorphous phase or a crystalline phase. Here, when the Fe-based alloy only has a crystalline phase, there is a problem that the Fe—B alloy crystals that inhibit the soft magnetic characteristics are precipitated, which cannot be used as a soft magnetic material. In addition, it can be seen that, compared to the case of the comparative examples only having an amorphous phase, the examples have a higher saturation magnetization value while maintaining the coercivity at a low level. Specifically, when the Fe content exceeds 79 mol %, it may be difficult to make amorphous powder particles and it may be difficult to increase the saturation magnetization to 168 emu/g or higher. In the present embodiment, the amorphousness is improved by replacing a portion of Fe with Co. In addition, as the Fe or Fe—Co crystalline phase is precipitated, the saturation magnetization may be significantly improved, and since the particle diameter of the crystalline phase is maintained to be fine, the coercivity does not change significantly and good soft magnetic characteristics may be exhibited.

According to an embodiment of the present disclosure, the Fe-based alloy in which loss is minimized, while having a high saturation magnetic flux density but a low coercivity, and the electronic component using the same may be implemented.

While example embodiments have been illustrated and described above, it will be apparent to those skilled in the art that modifications and variations could be made without departing from the scope of the present disclosure as defined by the appended claims.

What is claimed is:

1. An Fe-based alloy expressed by a compositional formula of (Fe₍₁₋ₓ₎Coₓ)ₐSi_{b}B_{c}P_{d}NbₑCu_{f}C_{g}, wherein x, a, b, c, e, and g satisfy the conditions of 10≤x≤20, 80.0≤a≤82.0, 0≤b≤4.0, 8.05c≤12.0, 0≤d≤4.0, 1.0≤e≤3.0, 0.5≤f≤1.0, 0≤g≤2.0.

2. The Fe-based alloy of claim 1, wherein the Fe-based alloy includes an amorphous phase and a crystalline phase.

3. The Fe-based alloy of claim 2, wherein the crystalline phase includes at least one selected from the group consisting of an Fe crystal and an Fe—Co crystal.

4. The Fe-based alloy of claim 2, wherein a content of the amorphous phase among the amorphous phase and the crystalline phase is 90% or more.

5. The Fe-based alloy of claim 2, wherein the crystalline phase exists within the amorphous phase.

6. The Fe-based alloy of claim 2, wherein an average particle diameter of the crystalline phase is 3 nm to 30 nm.

7. The Fe-based alloy of claim 1, wherein, in the compositional formula, b≤d.

8. An electronic component comprising:
a coil portion; and
a body covering the coil portion and including a plurality of magnetic particles,
wherein plurality of magnetic particles is expressed by a compositional formula of (Fe₍₁₋ₓ)Coₓ)ₐSi_{b}B_{c}P_{d}NbₑCu_{f}C_{g}, wherein x, a, b, c, e, and g satisfy the conditions of 10≤x≤20, 79.0≤a≤82.0, 0≤b≤4.0, 8.0≤c≤12.0, 0≤d≤4.0, 1.0≤e≤3.0, 0.5≤f≤1.0, and 0≤g≤2.0.

9. The electronic component of claim 8, wherein the Fe-based alloy includes an amorphous phase and a crystalline phase.

10. The electronic component of claim 9, wherein the crystalline phase includes at least one selected from the group consisting of an Fe crystal and an Fe—Co crystal.

11. The electronic component of claim 9, wherein a volume content of the amorphous phase among the amorphous phase and the crystalline phase is 90% or more.

12. The electronic component of claim 9, wherein the crystalline phase exists within the amorphous phase.

13. The electronic component of claim 9, wherein an average particle diameter of the crystalline phase is 3 nm to 30 nm.

14. The electronic component of claim 8, wherein, in the compositional formula, b≤d.

15. The electronic component of claim 8, further comprising a support substrate disposed within the body and supporting the coil portion.

16. The electronic component of claim 8, wherein the coil portion includes a winding-type coil.

17. The electronic component of claim 8, further comprising:
an external electrode disposed outside the body,
wherein the external electrode includes a conductive paste layer and a plating layer.
